(19) United States
(12) Patent Application Publication
(10) Pub. No.: US 2002/0191652 A1
(43) Pub. Date: Dec. 19, 2002

(54) Tunable laser source device

(76) Inventor: Nobuaki Ema, Tokyo (JP)

Correspondence Address: SAMUEL BORODACH, Fish & Richardson P.C., Suite 2800, 45 Rockefeller Plaza, New York, NY, 10111, US

(21) Appl. No.: 10/171,127

(22) Filed: Jun. 13, 2002

(30) Foreign Application Priority Data
Jun. 14, 2001 (JP) P. 2001-179459

(51) Int. Cl. H01S 3/10

(52) U.S. Cl. 372/20

(57) ABSTRACT

In a tunable laser source device for branching a light output from a tunable laser source portion 1 to supply to a wavelength measuring device 6 and a gas cell as a reference for calibrating wavelength 5 and then controlling the tunable laser source portion in response to an output of the wavelength measuring device, a temperature controlling device is provided to the wavelength measuring device to mate a result measured by the wavelength measuring device with an interval of a plurality of absorbed line wavelengths in the gas cell as a reference for calibrating wavelength.

### BACKGROUND OF THE INVENTION

The present invention relates to a tunable laser source device employed in evaluating or manufacturing the optical communication system or device.

A configuration of the tunable laser source device in the prior art will be explained with reference to FIG. 6 hereunder.

In FIG. 6, the light emitted from the tunable laser source portion 11 is output to the outside of the tunable laser source device via the optical coupler 18a as the optical output.

Also, the light branched by the optical coupler 18a is branched by the optical coupler 18b. One branched output is fed to the wavelength measuring device 16 that measures the wavelength by utilizing the periodical change of the interference power generated based on the deviation between optical path lengths in the etalon, etc. The other branched output is fed to the gas cell as a reference for calibrating wavelength 15 and the wavelength measuring device 16.

Also, detected outputs of the gas cell as a reference for calibrating wavelength 15 and the wavelength measuring device 16 are converted into electric signals and then fed to the control circuit 14 that is constructed by CPU.

Also, the control circuit 14 controls the wavelength of the light, that is output from the tunable laser source portion 11 via the motor driving circuit 12 and the LD current driving circuit 13, in response to the set signal from the user interface portion 17.

Next, the details of the tunable laser source portion 11 will be explained with reference to FIG. 5 hereunder.

FIG. 5 is a view showing a detailed configuration of the tunable laser source portion 11. This configuration is formed by the semiconductor laser (LD) 21, lenses 22a, 22b, the diffraction grating 23, the mirror 24, and the motor 25.

The light emitted from the semiconductor laser 21 is shaped into the parallel light by the lens 22a and then enters into the diffraction grating 23.

Only the light having the wavelength, which is decided by the positional relationship between the diffraction grating 23 and the mirror 24, out of the light incident into the diffraction grating 23 can be fed back to the semiconductor laser 21 once again. As a result, the light having the particular wavelength is output from the semiconductor laser 21 via the lens 22b.

If the external cavity length is changed by driving the motor 25 to rotationally move the position of the mirror 24 around the center O of rotation, the wavelength of this output light can be changed.

In this case, if the motor 25 is set simply to a predetermined position, sometimes the infinitesimal error is generated in the position of this mirror 24. Therefore, as shown in FIG. 6, the detected output of the wavelength measuring device 16 is fed back to the control circuit 14 such that the control is carried out by driving the motor 25 to mate always the measured wavelength with the predetermined wavelength.

Also, the wavelength of the light generated by the semiconductor laser can be controlled by adjusting the driving current of the semiconductor laser. Therefore, the wavelength of the light can be controlled by feeding back the detected output of the wavelength measuring device to the driving circuit of the semiconductor laser.

As described above, the wavelength measuring device that measures the wavelength by utilizing the periodical change of the interference power based on the deviation between optical path lengths in the etalon, etc. is employed as the wavelength measuring device in the tunable laser source device in FIG. 6. Therefore, in order to compensate the change in the deviation between the optical path lengths due to the change of the ambient temperature, the temperature controlling device for maintaining the wavelength measuring device at the constant temperature (temperature control) is provided.

Also, the gas cell as a reference for calibrating wavelength 15 is provided to the tunable laser source device in FIG. 6 and is used to calibrate the wavelength measuring device.

Next, the conventional calibration of the wavelength measuring device 16 in the tunable laser source device in FIG. 6 in the prior art will be explained with reference to a flowchart of FIG. 4 hereunder.

In this case, the gas cell as a reference for calibrating wavelength 15 in FIG. 6 looks for the wavelength, which is indicated by an arrow in FIG. 7 at one point, from already-known absorbed line wavelengths as the reference wavelength.

This already-known wavelength is set as the reference wavelength of the wavelength measuring device 16 in which, as shown in FIG. 7, the periodical change of the interference power is present.

First, when the tunable laser source device shown in FIG. 6 is carried out of the factory, the temperature controlling device (not shown) of the wavelength measuring device 16 in FIG. 6 is set to the reference temperature (step S11).

Then, the wavelength linearity correction table by which the output of the wavelength measuring device 16 in which the periodical change of the interference power is present, as shown in FIG. 7, is corrected on the basis of the reference wavelength is formulated, and then is stored in a memory means (not shown) in the control circuit 14 (step S12).

Step S11 and step S12 are carried out when the tunable laser source device is carried out of the factory of the device maker.

Then, when the tunable laser source device is used, similarly the user sets the temperature controlling device (not shown) of the wavelength measuring device 16 to the reference temperature, like step S11 (step S13).

Then, the wavelength calibration is carried out by the user to set the detected value of the already-known absorbed line wavelength of the gas cell as the origin of the detected outputs of the wavelength measuring device (step S14).

In this state, the measurement of the to-be-measured light output from the tunable laser source portion 11 is carried out by the wavelength measuring device 16 (step S15).

This measured result is arithmetically processed by using the wavelength linearity correction table, which is formulated in step S12, to calculate the detected wavelength (step S16).

The measured wavelength obtained by the process is output (step S17).

Step S15 to step S17 are repeated necessary times.

As shown in FIG. 7, the gas cell 15 has the characteristic to absorb the wavelength at the particular already-known one point. The absorbed line wavelengths of the gas cell are very stable to the environmental change such as the change of the ambient temperature and others.

In contrast, as shown in FIG. 3, the measured output of the wavelength measuring device 16 that utilizes the deviation between the optical path lengths changes to have peaks and notches of the power periodically.

However, the interval between the peak (notch) and the peak (notch) has the characteristic that depends on the change of the ambient temperature.

More particularly, as shown in FIG. 7, even though the wavelength linearity correction table is formulated at a certain ambient temperature while employing the absorbed line wavelength, that is indicated by an arrow, of the gas cell as a reference for calibrating wavelength 15 as the reference value of the measured output of the wavelength measuring device 16, such measured output of the wavelength measuring device 16 in FIG. 7 is expanded and contracted in the lateral axis direction if the ambient temperature is changed. As a result, the error is generated in the wavelength linearity correction table that is prepared at the time when the device is carried out of the factory.

Therefore, the temperature controlling device that maintains the temperature of the wavelength measuring device 16 constant must be operated in formulating the wavelength linearity correction table at the time when the device is carried out of the factory and in measuring the wavelength by the user.

Accordingly, there exists the following problem in the tunable laser source device set forth in FIG. 6 in the prior art.

Although the temperature control is applied to the wavelength measuring device, the infinitesimal temperature change is caused in the device if the ambient temperature of the device in formulating the wavelength linearity correction table at the time when the device is carried out of the factory is different from that of the device in user's employment. For this reason, such temperature change exerts not a little effect upon the wavelength measuring accuracy.

In order to maintain the wavelength accuracy obtained at the time when the device is carried out of the factory against the atmospheric temperature variation, the wavelength measuring device must be installed into the high performance temperature controlling mechanism (thermostatic bath). Normally, these high performance thermostatic baths are large in size and high in cost.

### SUMMARY OF THE INVENTION

It is an object of the present invention to overcome the problems of the tunable laser source device set forth in FIG. 6 in the prior art, more particularly the problem such that, when an ambient temperature of the device inuser's employment becomes different from that of the device in preparing a wavelength linearity correction table at the time when the device is carried out of a factory, a minute temperature change is caused in the device to have not a little effect on a wavelength measuring accuracy.

In order to overcome the above subjects, there is provided a tunable laser source device for branching a light output from a tunable laser source portion to supply to a wavelength measuring device and a gas cell as a reference for calibrating wavelength and then controlling the tunable laser source portion in response to an output of the wavelength measuring device,

wherein a temperature controlling device is provided to the wavelength measuring device to mate a result measured by the wavelength measuring device with an interval of a plurality of absorbed line wavelengths in the gas cell as a reference for calibrating wavelength.

According to this configuration, it is possible to overcome the problem such that, when the ambient temperature of the device in user's employment becomes different from that of the device in preparing the wavelength linearity correction table at the time when the device is carried out of the factory, the infinitesimal temperature change is caused in the device to have an effect on the wavelength measuring accuracy (Aspect 1).

Also, in the case of the wavelength measuring device that measures the wavelength by utilizing the periodical change of the interference power based on the deviation between optical path lengths, the influence of the change in the ambient temperature can be removed much more (Aspect 2).

Also, the wavelength measuring device can be formed of an etalon (Aspect 3).

Also, the wavelength of the optical output from the tunable laser source portion can be maintained constant by controlling the driving current of the semiconductor laser constituting the tunable laser source portion in response to the output of the wavelength measuring device (Aspect 4).

Also, the wavelength of the optical output from the tunable laser source portion can be maintained constant by operating the mirror constituting the tunable laser source portion in response to the output of the wavelength measuring device so as to control the external cavity length (Aspect 5).

Also, if the tunable laser source portion can sweep continuously its wavelength, such tunable laser source portion becomes more effective (Aspect 6).

### BRIEF DESCRIPTION OF THE DRAWINGS

FIG. 1 is a flowchart for explaining calibration of a tunable laser source device of the present invention.

FIG. 2 is a view showing a configuration of the tunable laser source device of the present invention.

FIG. 3 is a view showing a relationship of outputs between a wavelength measuring device and a gas cell as a reference for calibrating wavelength of the present invention.

FIG. 4 is a flowchart for explaining the calibration of the tunable laser source device in the prior art.

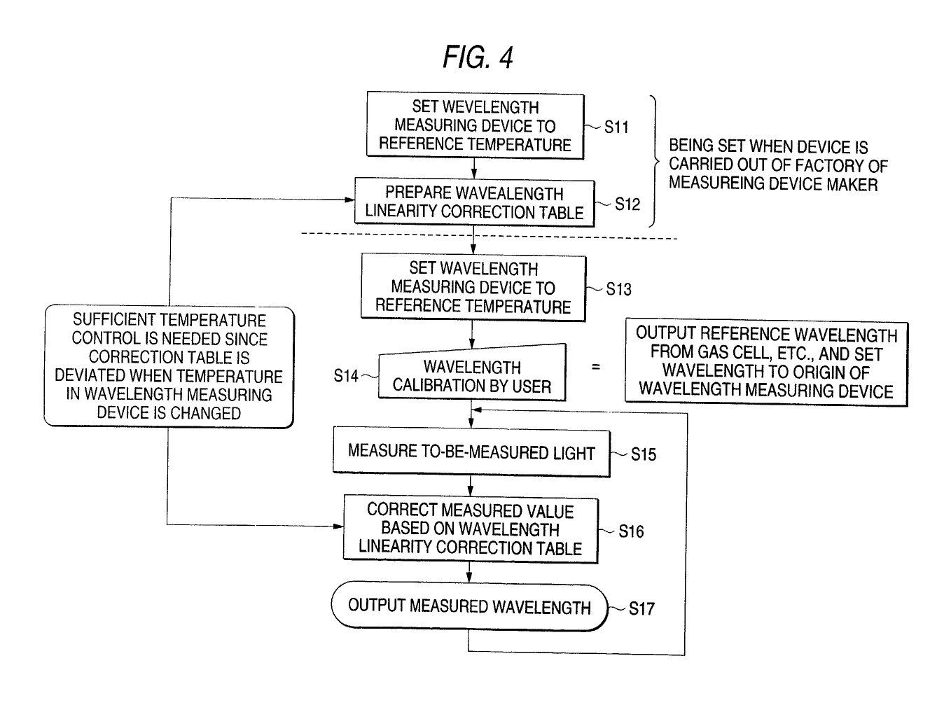

FIG. 5 is a view showing a configuration of a tunable laser source portion.

FIG. 6 is a view showing a configuration of the tunable laser source device in the prior art.

FIG. 7 is a view showing a relationship of outputs between the wavelength measuring device and the gas cell as a reference for calibrating wavelength in the prior art.

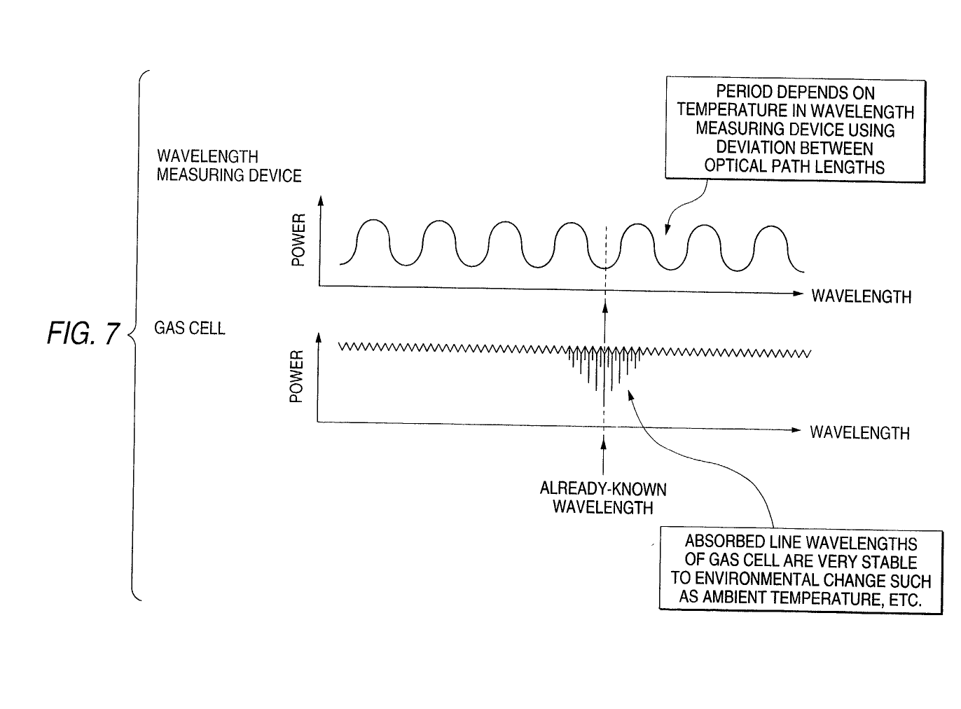

### DETAILED DESCRIPTION OF THE PREFERRED EMBODIMENTS

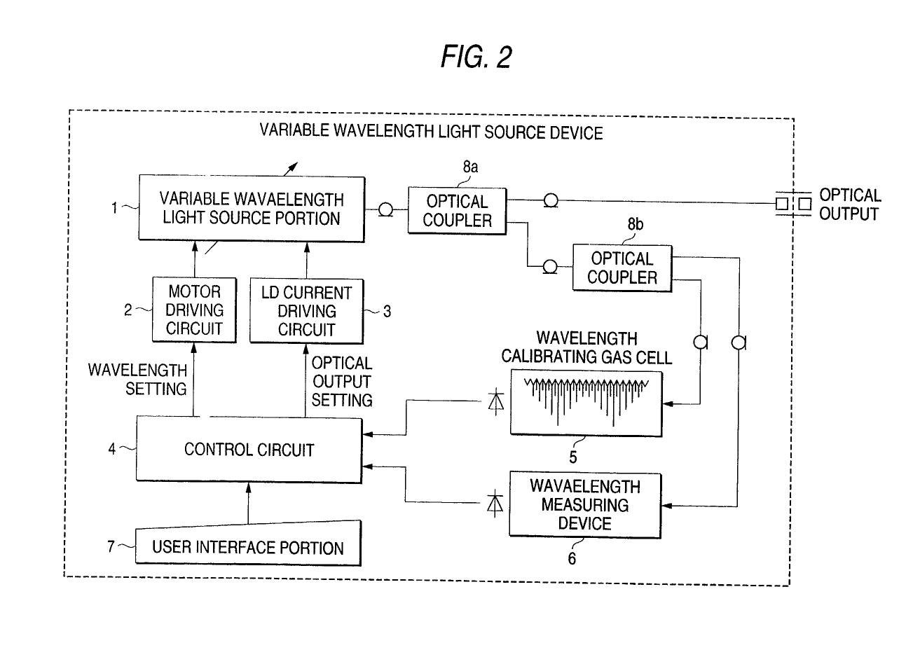

A configuration of a tunable laser source device of the present invention will be explained with reference to FIG. 2 hereunder.

In FIG. 2, a light emitted from a tunable laser source portion 1 is output to the outside of the tunable laser source device via an optical coupler 8a as an optical output.

Also, the light branched by the optical coupler 8a is branched by an optical coupler 18b. One branched output is supplied to a wavelength measuring device 6 that measures the wavelength by utilizing the periodical change of the interference power generated based on the deviation between the optical path lengths in the etalon, etc. The other branched output is supplied to a gas cell as a reference for calibrating wavelength 5 and a wavelength measuring device 6.

Also, detected outputs of the gas cell as a reference for calibrating wavelength 5 and the wavelength measuring device 6 are converted into electric signals and then supplied to a control circuit 4 that is constructed by CPU.

Also, the control circuit 4 controls the wavelength of the light, that is output from the tunable laser source portion 1 via a motor driving circuit 2 and an LD current driving circuit 3, in response to a set signal from a user interface portion 7.

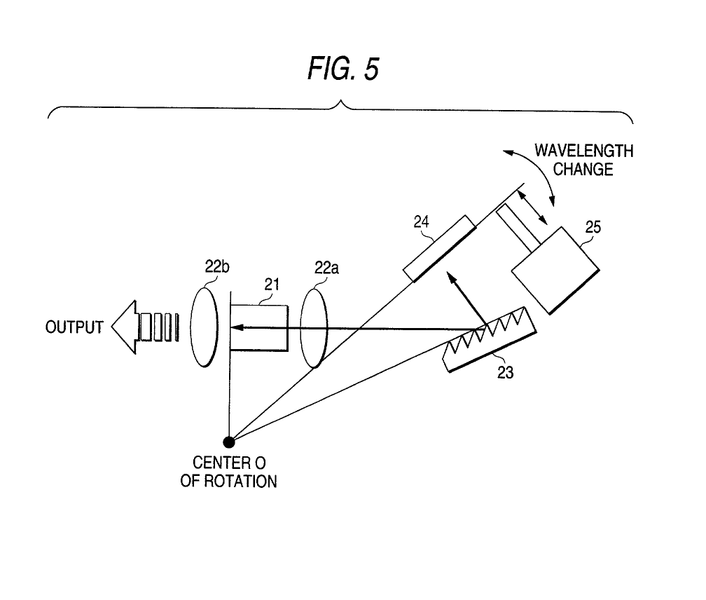

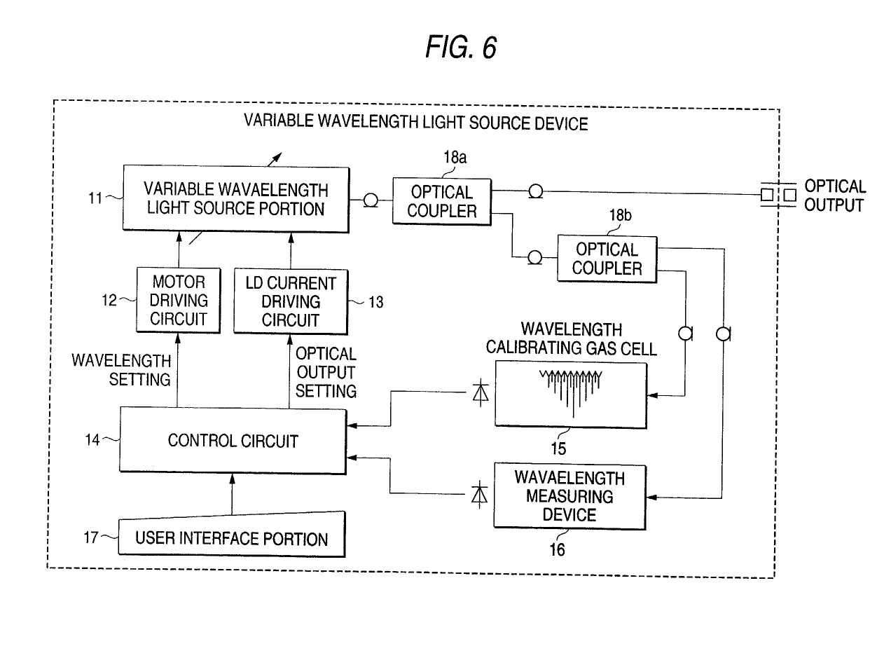

In addition, since details of the tunable laser source portion 1 are given like the description in FIG. 5 and are similar to those set forth in FIG. 6 in the prior art, their explanation will be omitted hereunder.

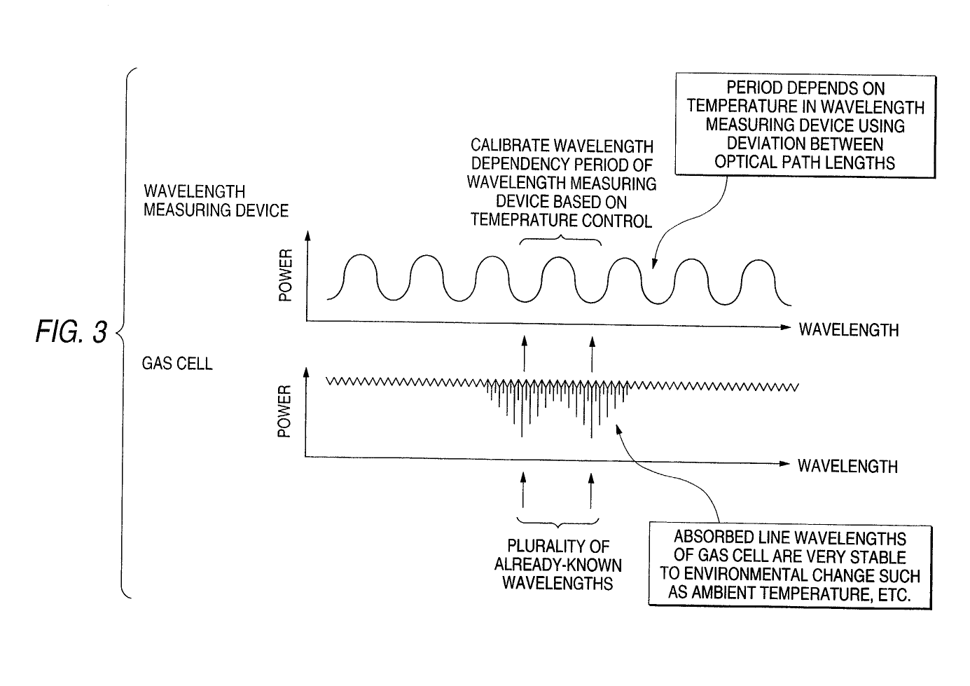

The feature of the tunable laser source device, which is set forth in FIG. 2 and to which the present invention is applied, in hardware is that a plurality of already-known absorbed line wavelengths indicated by arrows in FIG. 3 (two points in FIG. 3) exist in the gas cell as a reference for calibrating wavelength 5.

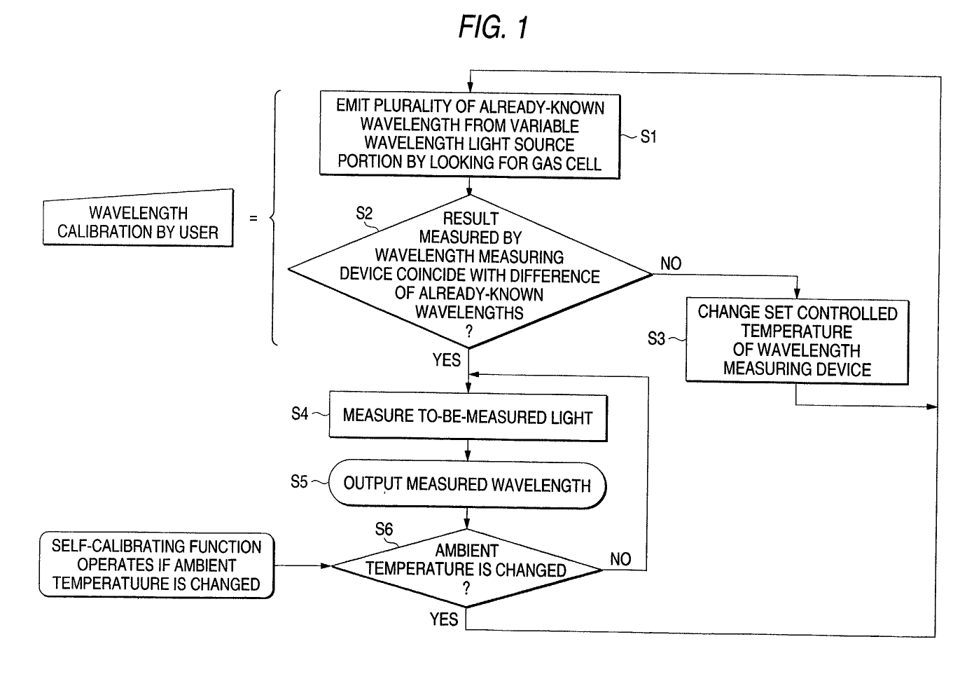

FIG. 1 is a flowchart for showing a calibration method of the tunable laser source device of the present invention.

Steps S1 to step S3 in FIG. 1 show a flow of the wavelength calibration by the user.

First, a plurality of already-known wavelengths (at least two points) are emitted from the tunable laser source portion (1 in FIG. 2) by looking for the gas cell (5 in FIG. 2) (step S1)

Then, it is decided whether or not the result measured by the wavelength measuring device (6 in FIG. 2) coincides with the difference of the already-known wavelengths (step S2).

If the decision in step S2 is No, the set temperature of the temperature controlling device (temperature control) in the wavelength measuring device (6 in FIG. 2) is changed (step S3).

If the decision in step S2 is Yes, the to-be-measured light is measured by the wavelength measuring device (step S4).

Then, the measured result (measured wavelength) is output (step S5).

Then, it is decided whether or not the ambient temperature was changed (step S6).

wavelength calibration by the user The self-calibrating function operates if the ambient temperature is changed.

If the decision in step S6 is Yes, the measurements in step S4 and step S5 are repeated.

If the decision in step S6 is No, the process goes back to step S1 and then the automatic calibrating function of carrying out the calibration once more is operated.

The contents of the calibration executed in step S1, step S2, and step S3 will be explained in detail with reference to FIG. 3 hereunder.

FIG. 3 is a view showing a relationship of outputs between the gas cell as a reference for calibrating wavelength (5 in FIG. 2) and the wavelength measuring device (6 in FIG. 2) that utilizes the periodical change of the interference power generated based on the deviation between the optical path lengths in the etalon, etc.

In FIG. 3, an abscissa denotes the wavelength and an ordinate denotes the power.

As shown in FIG. 3, the gas cell has the characteristic that absorbs a plurality of particular already-known wavelengths (two points in FIG. 3). The absorbed line wavelengths of the gas cell are very stable to the environmental change such as the ambient temperature, etc.

In contrast, as shown in FIG. 3, the measured output of the wavelength measuring device that utilizes the deviation between the optical path lengths is changed such that its power has the peak and the notch periodically.

In this case, the interval between the peak (notch) and the peak (notch) has the characteristic that depends on the change in the ambient temperature.

In other words, although the already-known absorbed line wavelength of the gas cell can correspond to two notches of the measured output of the wavelength measuring device that utilizes the deviation between the optical path lengths at a certain ambient temperature like FIG. 3, the measured output of the wavelength measuring device that utilizes the deviation between the optical path lengths in FIG. 3 is expanded and contracted in the lateral axis direction if the ambient temperature is changed. Thus, the absorbed line wavelength does not coincide with two notches of the measured output.

In step S3, if the measured output of the wavelength measuring device does not coincide with the already-known wavelength difference because of the change of the ambient temperature, the set temperature of the temperature controlling device in the wavelength measuring device is changed to mate the measured output with the already-known wavelength difference.

In other words, in the temperature control of the wavelength measuring device in the prior art, the control is carried out to mate the temperature with the predetermined value. In contrast, in the present invention, if the measured output of the wavelength measuring device and the already-known wavelength difference do not coincide with each other because of the change of the ambient temperature, they are caused to coincide mutually by changing the set temperature of the temperature controlling device in the wavelength measuring device.

In the invention set forth in Aspect 1, there is provided a tunable laser source device for branching a light output from a tunable laser source portion to supply to a wavelength measuring device and a gas cell as a reference for calibrating wavelength and then controlling the tunable laser source portion in response to an output of the wavelength measuring device, wherein a temperature controlling device is provided to the wavelength measuring device to mate a result measured by the wavelength measuring device with an interval of a plurality of absorbed line wavelengths in the gas cell as a reference for calibrating wavelength. Therefore, it is possible to overcome the problem such that, when the ambient temperature of the device in user's employment becomes different from that of the device in preparing the wavelength linearity correction table at the time when the device is carried out of the factory, the infinitesimal temperature change is caused in the device to have the effect on the wavelength measuring accuracy.

Also, in the inventions set forth in Aspects 2 and 3, in the case of the wavelength measuring device that measures the wavelength by utilizing the periodical change of the interference power based on the deviation between optical path lengths (e.g., etalon), the influence of the change in the ambient temperature can be eliminated much more.

In this manner, if the temperature of the wavelength measuring device is controlled so as to mate the interval measurement of the wavelengths with the result measured by the wavelength measuring device at two already-known wavelengths or more generated based on the absorbed line wavelengths of the gas cell, the very high wavelength linearity can be obtained at the wavelength that is out of the absorbed line wavelengths of the gas cell.

Also, in the invention set for thin Aspect 4, the wavelength of the optical output emitted from the tunable laser source portion can be maintained constant by controlling the driving current of the semiconductor laser constituting the tunable laser source portion in response to the output of the wavelength measuring device.

Also, in the invention set for thin Aspect 5, the wavelength of the optical output emitted from the tunable laser source portion can be maintained constant by operating a mirror constituting the tunable laser source portion in response to the output of the wavelength measuring device to control the external cavity length.

Also, in the invention set forth in Aspect 6, if particularly the tunable laser source portion having the configuration that is able to change its wavelength continuously, as shown in FIG. 5, is combined together, the effect of improving the wavelength accuracy in the continuous wavelength sweep can be increased.

These tunable laser source devices that are capable of sweeping the wavelength continuously with high accuracy can contribute the event that the accuracy in the measurement of the wavelength dependency characteristic of optical parts employed in the optical communication, etc. is increased considerably.

What is claimed is:

1. A tunable laser source device comprising:
a wavelength measuring device,
a tunable laser source portion,
a gas cell as a reference for calibrating wavelength,
said tunable laser source device for branching a light output from said tunable laser source portion to supply to said wavelength measuring device and said gas cell as a reference for calibrating wavelength, and controlling said tunable laser source portion in response to an output of said wavelength measuring device, wherein
said wavelength measuring device includes a temperature controlling device to mate a result measured by said wavelength measuring device with an interval of a plurality of absorbed line wavelengths in said gas cell as a reference for calibrating wavelength.

2. The tunable laser source device according to claim 1, wherein
said wavelength measuring device is a wavelength measuring device for measuring a wavelength by utilizing a periodical change of an interference power based on a deviation between optical path lengths.

3. The tunable laser source device according to claim 2, wherein
said wavelength measuring device is formed of an etalon.

4. The tunable laser source device according to claim 1, wherein
a driving current of a semiconductor laser constituting said tunable laser source portion is controlled in response to an output of said wavelength measuring device.

5. The tunable laser source device according to claim 1, wherein
an external cavity length is controlled by operating a mirror constituting said tunable laser source portion in response to an output of said wavelength measuring device.

6. The tunable laser source device according to claim 1, wherein
said tunable laser source portion is capable to sweep continuously the wavelength thereof.
